(19) United States
(12) Patent Application Publication
(10) Pub. No.: US 2023/0046108 A1
(43) Pub. Date: Feb. 16, 2023

(54) ELECTRONIC DEVICE AND METHOD FOR WIRELESS COMMUNICATION, AND COMPUTER-READABLE STORAGE MEDIUM

(71) Applicant: Sony Group Corporation, Tokyo (JP)

(72) Inventors: Zhikun WU, Beijing (CN); Chen SUN, Beijing (CN)

(73) Assignee: Sony Group Corporation, Tokyo (JP)

(21) Appl. No.: 17/791,934

(22) PCT Filed: Feb. 3, 2021
(86) PCT No.: PCT/CN2021/074991

§ 371 Date: Jul. 11, 2022

(30) Foreign Application Priority Data
Feb. 10, 2020 (CN) 202010084841.0

(51) Int. Cl. H04W 72/12; H04W 72/14; H04W 36/00; H04W 36/30

(52) U.S. Cl. CPC H04W 72/1263; H04W 72/1242; H04W 72/14; H04W 36/0072; H04W 36/30; H04W 72/1231; H04W 84/005

(57) ABSTRACT

Provided are an electronic device and a method for wireless communication, and a computer-readable storage medium. The electronic device comprises: a processing circuit configured to: determine that a physical layer problem occurs during transmission by a user equipment which uses a pre-configured resource in a pre-configured resource pool to execute the transmission; and determine, according to a transmission quality requirement of a data packet to be sent, the length of time during which the user equipment can continue using the pre-configured resource.

This application claims priority to Chinese Patent Application No. 202010084841.0 titled “ELECTRONIC DEVICE AND METHOD FOR WIRELESS COMMUNICATION, AND COMPUTER-READABLE STORAGE MEDIUM”, filed on Feb. 10, 2020 with the China National Intellectual Property Administration (CNIPA), which is incorporated herein by reference in its entirety.

### FIELD

The present disclosure relates to the technical field of wireless communications, and in particular to the technology of using configured grant resources. More specifically, the present disclosure relates to an electronic apparatus and a method for wireless communications, and a computer-readable storage medium.

### BACKGROUND

Under the background of the rapid growth of the number of automobiles, traffic accidents caused by the automobiles occur frequently. In order to avoid more huge losses caused by the traffic accidents, vehicle-to-everything (V2X) Internet of vehicles technology has been developed rapidly. V2X Internet of vehicles can provide safety warning for vehicle driving, avoid congested and dangerous road sections, improve driving safety and reduce occurrences of traffic accidents. The conventional V2X technology can solve communication problems between vehicles, vehicles and pedestrians, vehicles and network infrastructure, and vehicles and networks. In the conventional V2X technology, LTE-V2X technology is a more mainstream technology, which can acquire relatively safe, reliable and efficient communication capability in a state of high-speed movement, and can make effective use of relevant resources. With the relevant research of 5G-NR and the development of the standardization, NR-V2X becomes a hot research issue.

In NR-V2X, resources allocated by a base station to user equipment (UE) are classified into several categories. One of the categories is dynamically scheduled resources and another of the categories is configured grant resources. The configured grant resources are classified into configured grant type 1 resources and configured grant type 2 resources. A main difference between the two types of configured grant resources is that the UE may use the configured grant type 1 resources when acquiring a time-frequency location of the corresponding configured grant resources via radio resources control (RRC) signaling until the RRC notifies the UE to stop using (or a maximum available time duration is reached); as for the configured grant type 2 resources, when the UE acquires a time-frequency location of the configured grant type 2 resources via the RRC signaling, it is further required that the base station performs activation/deactivation through downlink control information (DCI) transmitted on a physical downlink control channel (PDCCH).

In LTE-V2X, if the UE detects a physical layer problem, the UE cannot use the above configured grant resources any longer. Alternatively, the UE communicates on an exceptional pool until RRC reconnection is completed or a first transmission mode (model) in which resources are allocated from the base station is switched to a second transmission mode (mode2) in which the UE autonomously selects resources. A resource allocation mode used in the exceptional pool is a random resource allocation mode, and thus it is easy to produce collision in a communication process to reduce the reliability of the communication. In NR-V2X, some businesses are required to achieve reliability of 99.999%.

### SUMMARY

In the following, an overview of the present disclosure is given simply to provide basic understanding to some aspects of the present disclosure. It should be understood that this overview is not an exhaustive overview of the present disclosure. It is not intended to determine a critical part or an important part of the present disclosure, nor to limit the scope of the present disclosure. An object of the overview is only to give some concepts in a simplified manner, which serves as a preface of a more detailed description described later.

An electronic apparatus for wireless communications is provided according to an aspect of the present disclosure. The electronic apparatus includes processing circuitry. The processing circuitry is configured to: determine that a physical layer problem occurs on transmission of user equipment which utilizes configured grant resources in a configured grant resource pool to perform the transmission; and determine, according to a transmission quality requirement of a data packet to be transmitted, a time duration during which the user equipment can continue utilizing the configured grant resources.

A method for wireless communications is provided according to an aspect of the present disclosure. The method includes: determining that a physical layer problem occurs on transmission of user equipment which utilizes configured grant resources in a configured grant resource pool to perform the transmission; and determining, according to a transmission quality requirement of a data packet to be transmitted, a time duration during which the user equipment can continue utilizing the configured grant resources.

An electronic apparatus for wireless communications is provided according to another aspect of the present disclosure. The electronic apparatus includes processing circuitry.

The processing circuitry is configured to: provide, to user equipment which is to utilize configured grant resources in a configured grant resource pool to perform transmission, a mapping relationship between transmission quality requirements of data packets to be transmitted and the time durations during which the user equipment can continue utilizing the configured grant resources after detecting a physical layer problem; and configure the configured grant resources for the user equipment.

A method for wireless communications is provided according to another aspect of the present disclosure. The method includes: providing, to user equipment which is to utilize configured grant resources in a configured grant resource pool to perform transmission, a mapping relationship between transmission quality requirements of data packets to be transmitted and the time durations during which the user equipment can continue utilizing the configured grant resources after detecting a physical layer problem; and configuring the configured grant resources for the user equipment.

With the electronic apparatus and the method according to the present disclosure, the communication reliability of the user equipment utilizing the configured grant resources to transmit during the time duration when the physical layer problem occurs can be effectively improved.

According to other aspects of the present disclosure, there are further provided computer program codes and computer program products for implementing the methods for wireless communications above, and a computer readable storage medium having recorded thereon the computer program codes for implementing the methods for wireless communications described above.

These and other advantages of the present disclosure will be more apparent by illustrating in detail a preferred embodiment of the present disclosure in conjunction with accompanying drawings below.

### BRIEF DESCRIPTION OF THE DRAWINGS

To further set forth the above and other advantages and features of the present disclosure, detailed description will be made in the following taken in conjunction with accompanying drawings in which identical or like reference signs designate identical or like components. The accompanying drawings, together with the detailed description below, are incorporated into and form a part of the specification. It should be noted that the accompanying drawings only illustrate, by way of example, typical embodiments of the present disclosure and should not be construed as a limitation to the scope of the disclosure. In the accompanying drawings:

FIG. 1 is a block diagram showing function modules of an electronic apparatus for wireless communications according to an embodiment of the present disclosure;

FIG. 2 is a schematic flow chart of an operation of the UE;

FIG. 3 shows an example of a mapping relationship;

FIG. 4 is a block diagram showing function modules of an electronic apparatus for wireless communications according to an embodiment of the present disclosure;

FIG. 5 shows an example of an information procedure between a base station and UE;

FIG. 6 is a schematic diagram showing an operation procedure between UE and a base station;

FIG. 7 shows an example of an information procedure between a base station and UE;

FIG. 8 is a block diagram showing function modules of an electronic apparatus for wireless communications according to another embodiment of the present disclosure;

FIG. 9 is a block diagram showing function modules of an electronic apparatus for wireless communications according to another embodiment of the present disclosure;

FIG. 10 shows a flow chart of a method for wireless communications according to an embodiment of the present disclosure;

FIG. 11 shows a flow chart of a method for wireless communications according to another embodiment of the present disclosure;

FIG. 12 is a block diagram showing a first example of an exemplary configuration of an eNB or gNB to which the technology according to the present disclosure may be applied;

FIG. 13 is a block diagram showing a second example of an exemplary configuration of the eNB or gNB to which the technology according to the present disclosure may be applied;

FIG. 14 is a block diagram showing an example of an exemplary configuration of a smartphone to which the technology according to the present disclosure may be applied;

FIG. 15 is a block diagram showing an example of an exemplary configuration of a car navigation apparatus to which the technology according to the present disclosure may be applied; and

FIG. 16 is a block diagram of an exemplary block diagram illustrating the structure of a general purpose personal computer capable of realizing the method and/or device and/or system according to the embodiments of the present disclosure.

### DETAILED DESCRIPTION OF EMBODIMENTS

An exemplary embodiment of the present disclosure will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a business, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the present disclosure due to unnecessary details, only a device structure and/or processing steps closely related to the solution according to the present disclosure are illustrated in the accompanying drawing, and other details having little relationship to the present disclosure are omitted.

### First Embodiment

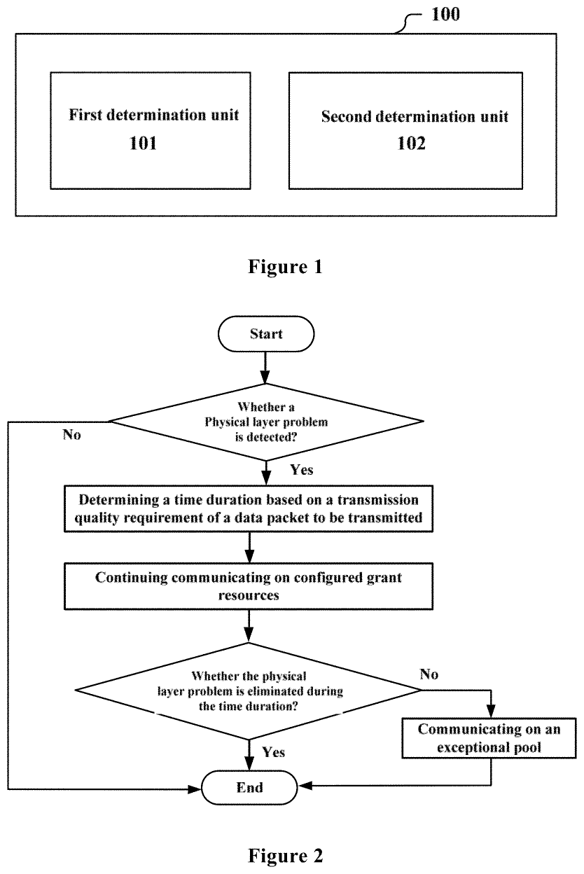

FIG. 1 is a block diagram showing function modules of an electronic apparatus 100 for wireless communication according to an embodiment of the present disclosure. As shown in FIG. 1, the electronic apparatus 100 includes a first determination unit 101 and a second determination unit 102. The first determination unit 101 is configured to determine that a physical layer problem occurs on transmission of UE which utilizes configured grant resources in a configured grant resource pool to perform the transmission. The second determination unit 102 is configured to determine, according to a transmission quality requirement of a data packet to be transmitted, a time duration during which the UE can continue utilizing the configured grant resources.

The first determination unit 101 and the second determination unit 102 may be implemented by one or more processing circuitries, and the processing circuitries may be implemented, for example, as a chip. Moreover, it should be understood that various functional units in the apparatus shown in FIG. 1 are only logical modules divided according to respective specific functions, and are not intended to limit specific implementation manners.

The electronic apparatus 100 may be, for example, arranged on a UE side, or may be communicatively connected to the UE. Here, it is further to be noted that the electronic apparatus 100 may be implemented in a chip level or an apparatus level. For example, the electronic apparatus 100 may function as the UE itself and may further include external devices such as a memory and a transceiver (not shown in FIG. 1). The memory may be configured to store programs which are required to be executed when the UE implements various functions and related data information. The transceiver may include one or more communication interfaces to support communications with different apparatus (for example, a base station, other UE or the like). Implementations of the transceiver are not limited herein.

It should be noted that the embodiments of the present disclosure may be applied to an NR-V2X scenario to improve the reliability of communication. However, this is not restrictive, and the embodiments may be applied to any other scenarios with similar requirements. In the following description, for ease of understanding, an NR-V2X application is taken as an example in appropriate situations.

As described above, when the physical layer problem occurs, it means that the UE cannot continue utilizing the configured grant resources. Therefore, the UE is required to perform an operation such as cell reselection. During a transition time duration (also referred as a problem time period) before connection is re-established, the continuity and reliability of communication are expected to be ensured.

The first determination unit 101 determines that the physical layer problem occurs when a predetermined number of out of sync instructions are continuously received on a lower layer, for example, in a case of not performing cell reselection or handover. This is not restrictive, and the first determination unit 101 may determine that the physical layer problem occurs utilizing various techniques.

In an example, when it is determined that the physical layer problem occurs, an existing timer T310 is started to time. Thereafter, if the physical layer problem is solved before the timer T310 expires, the UE may continue utilizing the previous configured grant resources for communication; and if the physical layer problem is not solved when the timer T310 expires, it may further be detected that a wireless link fails, and an existing timer T311 is started and cell reselection is performed.

In the embodiment, when a physical layer problem occurs, the UE may continue utilizing the configured grant resources for communication during the time duration to wait for eliminating the physical layer problem at the same time. For example, the time duration during which the UE can continue utilizing the configured grant resources may be determined according to the transmission quality requirement of the data packet to be transmitted. If the physical layer problem is still not eliminated after the time duration passes, the UE may switch to an exceptional pool to communicate. A schematic flow chart of the operation of the UE is shown in FIG. 2. It is noted that the physical layer problem described herein may further include a case of wireless link failure.

The transmission quality requirement includes, for example, one or more of the following: a requirement of reliability and a requirement of priority level. The transmission quality requirement indicates importance of a data packet from one aspect. For example, the higher the transmission quality requirement of the data packet to be transmitted is, the longer the time duration during which the user equipment can continue utilizing the configured grant resources is, to ensure the reliability of data transmission.

For example, existing timers such as a timer T304, a timer T310 and a timer T311 may be used to measure the time duration. Alternatively/as a supplement a new timer may be arranged to measure the time duration.

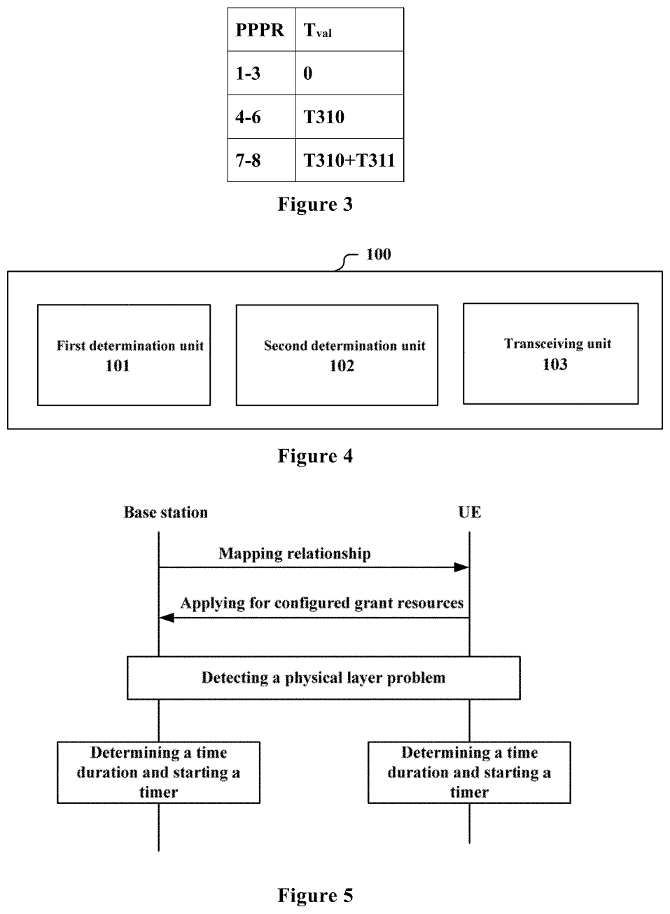

In an example, the second determination unit 102 is configured to determine, based on a mapping relationship between the transmission quality requirement of the data packet to be transmitted and the time duration, a time duration corresponding to the transmission quality requirement. For ease of understanding, an example of the mapping relationship is described below with reference to FIG. 3.

FIG. 3 shows an example of a mapping relationship between a ProSe Per-Packet Reliability (PPPR) requirement and a time duration Tᵥₐₗ. In a case that the PPPR requirement is one of 1 to 3 and the time duration Tᵥₐₗ is 0, that is, the UE is not allowed to continue utilizing the configured grant resources when a physical layer problem occurs. In a case that the PPPR requirement is one of 4 to 6, and the time duration Tvai is the time duration of the timer T310, that is, the UE may continue utilizing the configured grant resources until the timer T310 expires when a physical layer problem occurs. If the physical layer problem is still not solved or the wireless link failure occurs when the T310 expires, the UE may be switched to the exceptional pool to communicate. In a case that the PPPR requirement is one of 7 to 8, and the time duration Tᵥₐₗ is a sum of the time duration of the timer T310 and the time duration of the timer T311, that is, the UE may continue utilizing the configured grant resources until the timer T310 expires and then the timer T311 expires when a physical layer problem occurs (and further the wireless link failure occurs). If the cell reselection is not completed after the time duration Tᵥₐₗ passes, the UE may switch to the exceptional pool to communicate.

In an example shown in FIG. 3, the existing timers T310 and T311 are used. FIG. 3 is only an example and is not restrictive. The time duration and the necessary timers may be set as needed.

FIG. 4 is another block diagram showing function modules of the electronic apparatus 100. In addition to the units shown in FIG. 1, the electronic apparatus 100 further includes a transceiving unit 103. The transceiving unit 103 is configured to perform relevant transceiving functions. For example, the transceiving unit 103 is configured to acquire the above mentioned mapping relationship from a base station in advance. The transceiving unit 103 is configured to acquire the mapping relationship via RRC signaling or a system information block (SIB).

In addition, the transceiving unit 103 is further configured to report the transmission quality requirement of the data packet to be transmitted to the base station. The report may be performed, for example, when applying for the configured grant resources from the base station.

FIG. 5 shows an example of an information procedure between a base station and UE. First, the base station informs the UE of the mapping relationship in advance, for example, via the RRC signaling or the SIB, and the UE then applies for configured grant resources from the base station, for example, via a scheduling request/buffer state report (BSR). The SR/BSR may include the transmission quality requirement of the data packet to be transmitted, such as PPPR. The UE then transmits on the configured grant resources allocated by the base station. When the physical layer problem is detected, the UE determines a time duration during which the user equipment can continue utilizing the configured grant resources according to the acquired mapping relationship and the transmission quality requirement of the data packet to be transmitted, and starts a corresponding timer. In addition, the base station also determines the time duration and starts the corresponding timer. In other words, some functions of the electronic apparatus 100 may also be performed on a base station side.

In an example, the second determination unit 102 is further configured to determine that a wireless link for transmission of the user equipment fails and the UE performs cell reselection. In a case that a new base station connected after reselection is different from an original base station connected before reselection, the transceiving unit 103 is further configured to provide an identifier (ID) of the original base station and an identifier of the UE in the original base station to the new base station. In this way, the new base station may inform the original base station to release the configured grant resources previously allocated to the UE via, for example, an X2 interface.

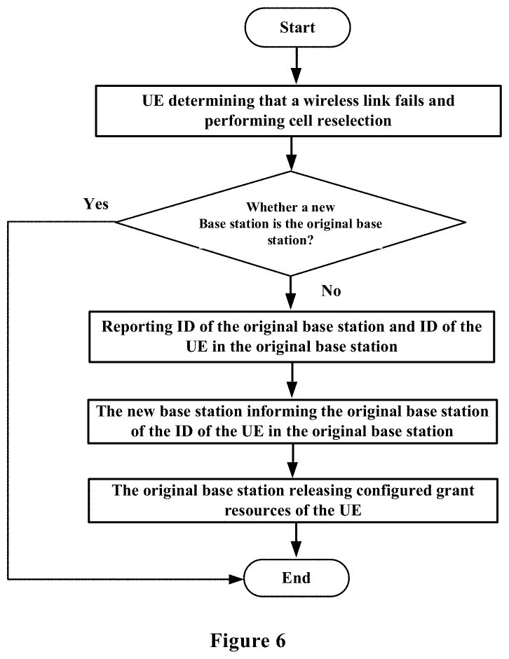

FIG. 6 is a schematic diagram showing an operation procedure of the example. The UE detects a wireless link failure during the process of communication utilizing the configured grant resources and performs cell reselection. After the cell reselection is completed, it is determined whether the new base station is the same as the original base station. If the new base station is the same as the original base station, no operation is performed. If the new base station is different from the original base station, the ID of the original base station and the ID of the UE in the original base station are reported to the new base station. The new base station identifies the original base station based on the ID of the original base station, and notifies the original base station of the ID of the UE in the original base station. The original base station releases the configured grant resources previously allocated to the UE when receiving the ID.

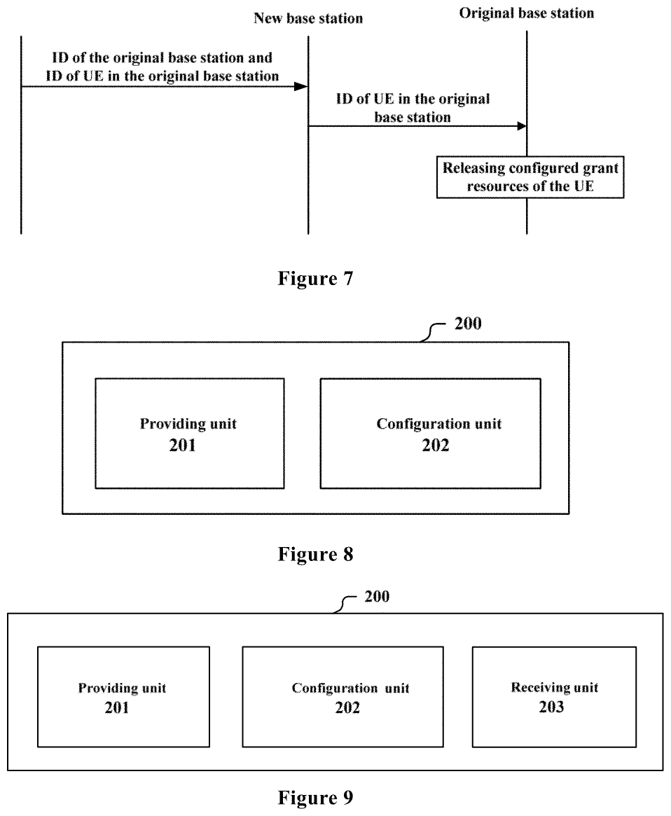

Accordingly, FIG. 7 shows an example of an information procedure between a base station and UE. There is signaling interaction as described above between the UE and the new base station and between the new base station and the original base station.

In this way, the configured grant resources of the original cell for the UE can be released in time after the UE performs cell reselection, so as to improve utilization of the spectrum.

It is noted that if a mapping relationship of the new base station is different from a mapping relationship of the original base station, the UE acquires a new mapping relationship from the new base station for updating; and if the mapping relationship of the new base station is the same as the mapping relationship of the original base station, in a case that the original base station shares the mapping relationship with the new base station, the UE may continue utilizing the original mapping relationship.

In an example, it is assumed that the UE is currently connected to a cell A, and it can be known that the time duration Tvai during which the UE can continue utilizing the configured grant resources is the sum of the time duration of the timer T310 and the time duration of the timer T311 (Tᵥₐₗ=T310+T311) when the physical layer problem occurs according to the mapping relationship. If the UE detects that the physical layer problem occurs (the timer T310 starts timing) and then detects that the wireless link fails (the timer T311 starts timing), the UE initiates the cell reselection. If the UE is reselected a cell B instead of the cell A, the UE may report, through PUCCH after completing RRC reconnection, ID of the cell A such as a physical cell identifier (PCI) and an identifier of the UE in the cell A such as a C-RNTI value. The Cell B provides the C-RNTI value to a base station of the cell A through an interface between cells, such as an X2 interface, to notify the cell A that the user has been reselected to the cell B, so that the cell A may release the configured grant resources related to the UE. The cell A releases the corresponding configured grant resources related to the UE when receiving the notification.

In summary, the electronic apparatus 100 according to the embodiment can effectively improve the communication reliability of the user equipment utilizing the configured grant resources to transmit during the problem time period when the physical layer problem occurs, and release the configured grant resources of the original cell in time when reselection occurs, so as to improve the resource utilization efficiency.

It is noted that the various information procedures described above are only exemplary rather than restrictive.

### Second Embodiment

In the embodiment, the proposed solution may further be applied to a handover scenario. For example, in the NR-V2X scenario, if a vehicle as a user moves rapidly, handover between different cells would occur. In view of the high reliability requirement of the NR-V2X scenario, it is required to ensure the communication reliability during handover.

An example of improving the communication reliability during handover is described below.

As shown in FIG. 1, the first determination unit 101 of the electronic apparatus 100 is configured to determine that the UE is to perform handover from a currently connected first base station to a second base station. In a handover process, the UE utilizes configured grant resources in a configured grant resource pool of the second base station. Accordingly, the second determination unit 102 is configured to determine, according to a transmission quality requirement of a data packet to be transmitted, a time duration during which the user equipment can utilize the configured grant resources.

In a case that the first base station and the second base station utilize the same mapping relationship, the second determination unit 102 is configured to determine a time duration during which the UE can utilize the configured grant resources of the second base station based on the existing mapping relationship. For example, the time duration may be measured by the existing timer, such as the timer T304, or may be measured by a newly provided timer.

An indication that the first base station and the second base station utilize the same mapping relationship may be included in a handover command from the first base station.

In a case that the first base station and the second base station utilize different mapping relationships, the transceiving unit 103 may be configured to acquire a mapping relationship of the second base station through a handover command from the first base station. The second determination unit 102 is configured to determine the time duration during which the UE can utilize the configured grant resources of the second base station based on the newly acquired mapping relationship.

Alternatively, the transceiving unit 103 may further be configured to acquire information of the time duration during which the UE can utilize the configured grant resources of the second base station through the handover command. In this case, the UE may acquire the mapping relationship of the second base station from the second base station when the handover is successful.

In this way, in the handover process, the configured grant resources of the second base station may be used for communication rather than the exceptional pool, so as to improve the communication reliability.

If the handover is successful, the UE may continue utilizing the configured grant resources of the second base station for communication. On the other hand, in a case that the handover fails and the UE is connected to a third base station different from the second base station after cell reselection, the transceiving unit 103 is further configured to provide an identifier of the second base station and an identifier of the UE in the second base station to the third base station. Similarly, the third base station identifies the second base station through the identifier of the second base station, and transmits the identifier of the UE in the second base station to the second base station, so that the second base station releases the corresponding configured grant resources.

In summary, an electronic apparatus 200 according to the embodiment can effectively improve the communication reliability of the user equipment utilizing the configured grant resources to transmit during a transition time duration when handover is performed, and release the configured grant resources of the original cell in time when reselection occurs, so as to improve the resource utilization efficiency.

It should be understood that the solution in the first embodiment and the solution in the second embodiment may be may be implemented in combination with each other or separately, that is, the electronic apparatus 100 may be applied to one of the scenario of physical layer problem occurring and the handover scenario, or both the scenarios, which is not restrictive.

### Third Embodiment

FIG. 8 is a block diagram showing functional modules of an electronic apparatus 200 for wireless communications according to another embodiment of the present disclosure. As shown in FIG. 8, the electronic apparatus 200 includes a providing unit 201 and a configuration unit 202. The providing unit 201 is configured to provide, to UE which is to utilize configured grant resources in a configured grant resource pool to perform transmission, a mapping relationship between the transmission quality requirement of the data packet to be transmitted and the time duration during which the user equipment can continue utilizing the configured grant resources after detecting a physical layer problem. The configuration unit 202 is configured to configure the configured grant resources for the user equipment.

The providing unit 201 and the configuration unit 202 may be implemented by one or more processing circuitries, and the processing circuitries may be implemented, for example, as a chip. Moreover, it should be understood that various functional units in the apparatus shown in FIG. 8 are only logical modules divided according to respective specific functions, and are not intended to limit specific implementation manners.

The electronic apparatus 200 may be, for example, arranged on a base station side, or may be communicatively connected to the base station. Here, it is further to be noted that the electronic apparatus 200 may be implemented in a chip level or an apparatus level. For example, the electronic apparatus 200 may function as the base station itself and may further include external devices such as a memory and a transceiver (not shown). The memory may be configured to store programs which are required to be executed when the base station implements various functions and related data information. The transceiver may include one or more communication interfaces to support communications with different apparatus (for example, user equipment, another base station or the like). Implementations of the transceiver are not limited herein.

For example, the providing unit 201 may be configured to provide the mapping relationship to the UE via RRC signaling or a SIB. The mapping relationship is described in detail in the first embodiment and is not repeated herein.

The transmission quality requirement includes, for example, one or more of the following: a requirement of reliability and a requirement of priority level. The mapping relationship may be configured so that the higher the transmission quality requirement of the data packet to be transmitted is, the longer the time duration during which the user equipment can continue utilizing the configured grant resources is.

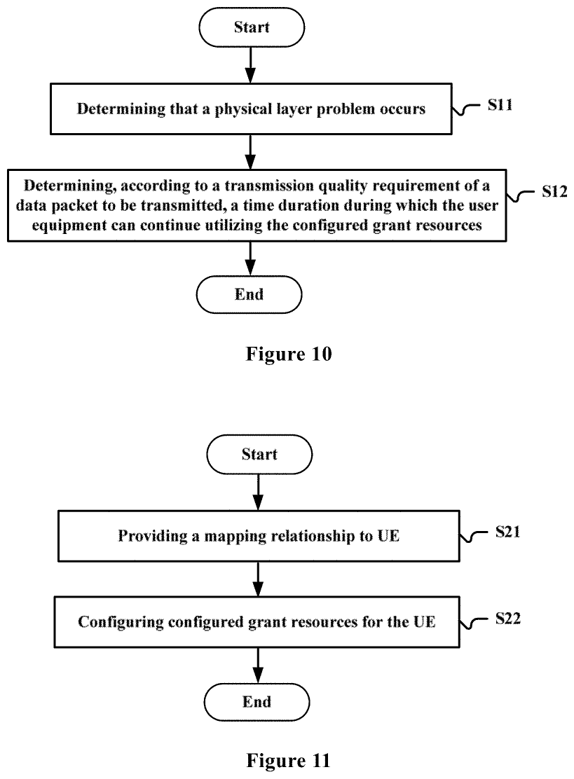

In addition, as shown in FIG. 9, the electronic apparatus 200 may further include a receiving unit 203. The receiving unit 203 is configured to receive the transmission quality requirement of the data packet to be transmitted of the UE from the UE. For example, the transmission quality requirement may be included in a configured grant resource request of the UE, such as SR/BSR.

When a physical layer problem occurs, for example, the configuration unit 202 may further determine, according to the mapping relationship and the transmission quality requirement of the data packet to be transmitted, the time duration during which the user equipment can continue utilizing the configured grant resources, and start a corresponding timer.

In an example, the electronic apparatus 200 corresponds to the first base station to which the UE is connected before reselection. In a case that the UE is reselected to another cell, the receiving unit 203 is further configured to receive, from the corresponding second base station, information of an identifier of the UE in the first base station and indication information indicating that the UE has been reselected to the second base station. The receiving unit 203 may receive the information and the indication information via the X2 interface. In this case, the configuration unit 202 releases the configured grant resources previously configured for the UE.

If the first base station shares the mapping relationship with the second base station, the UE may continue utilizing the previous mapping relationship. If the first base station does not share the mapping relationship with the second base station, the second base station transmits a new mapping relationship to the UE.

It should be noted that the above situation may occur in the cell reselection scenario or in the handover scenario. The UE reports the ID of the first base station and the ID of the UE in the first base station to the second base station when the reselection is completed. The second base station identifies the first base station according to the ID of the first base station, and notifies the first base station of the ID of the UE in the first base station and the fact that the UE corresponding to the ID has been reselected to the second base station, so that the first base station releases the configured grant resources previously allocated to the UE.

In the handover scenario, for example, the UE tries to perform handover to the first base station different from the second base station but the handover fails, and then the UE is connected to the second base station through reselection. At this time, the first base station is a base station to which the UE is connected before reselection. Similarly, the UE reports the ID of the first base station and the ID of the UE in the first base station to the second base station. The second base station identifies the first base station according to the ID of the first base station and informs the first base station to release the configured grant resources previously allocated to the UE.

In another example, in the handover scenario, the electronic apparatus 200 corresponds to the first base station to which the UE is currently connected. The providing unit 201 is further configured to transmit, to the UE, a handover command indicating that the UE is switched from the first base station to the second base station. For example, the handover command may include one of the following: an indication that the mapping relationship of the first base station is the same as the mapping relationship of the second base station; the mapping relationship of the second base station; and information of a time duration during which the UE can utilize configured grant resources of the second base station.

In a case that the mapping relationship of the first base station is the same as the mapping relationship of the second base station, the UE may determine the time duration during which the UE can utilize the configured grant resources of the second base station based on the previously acquired mapping relationship of the first base station. In a case that the mapping relationship of the first base station is different from the mapping relationship of the second base station, the UE may determine the time duration based on the mapping relationship of the second base station, or the UE may directly determine the time duration based on the received information. In such a case, the UE may acquire a new mapping relationship from the second base station after the handover is successful.

In another example, the UE is reselected from the original base station to a base station corresponding to the electronic apparatus 200. The receiving unit 203 is further configured to receive, from the UE, the identifier of the original base station and the identifier of the UE in the original base station. In such a case, the providing unit 201 is configured to transmit, to the original base station, information of the identifier of the UE in the original base station and indication information indicating that the UE has been switched to the present base station. For example, the information and the indication information may be transmitted via the X2 interface.

In the handover scenario, as described above, the original base station may be a base station to which the UE tries to perform handover but finally fails to switch.

The relevant information procedure in the embodiment has been described in detail in the first embodiment, and is not repeated herein.

In summary, the electronic apparatus 200 according to the present embodiment can effectively improve the communication reliability of the user equipment utilizing the configured grant resources to transmit during a transition time duration when the physical layer problem occurs or handover is performed, and release the configured grant resources of the original cell in time when reselection occurs, so as to improve the resource utilization efficiency.

### Fourth Embodiment>

In the above description of embodiments of the electronic apparatuses for wireless communications, it is apparent that some processing and methods are further disclosed. In the following, a summary of the methods are described without repeating details that are described above. However, it should be noted that although the methods are disclosed when describing the electronic apparatuses for wireless communications, the methods are unnecessary to adopt those components or to be performed by those components described above. For example, implementations of the electronic apparatuses for wireless communications may be partially or completely implemented by hardware and/or firmware. Methods for wireless communications to be discussed blow may be completely implemented by computer executable programs, although these methods may be implemented by the hardware and/or firmware for implementing the electronic apparatuses for wireless communications.

FIG. 10 is a flow chart of a method for wireless communications according to an embodiment of the present disclosure. The method includes: determining that a physical layer problem occurs on transmission of user equipment which utilizes configured grant resources in a configured grant resource pool to perform the transmission (S11); and determining, according to a transmission quality requirement of a data packet to be transmitted, a time duration during which the user equipment can continue utilizing the configured grant resources (S12). The method may be performed on a UE side, for example.

The transmission quality requirement may include, for example, one or more of the following: a requirement of reliability and a requirement of priority level. The higher the transmission quality requirement of the data packet to be transmitted is, the longer the time duration during which the user equipment can continue utilizing the configured grant resources is.

In step S12, a time duration corresponding to the transmission quality requirement may be determined based on a mapping relationship between the transmission quality requirement of the data packet to be transmitted and the time duration. The mapping relationship may be acquired from the base station in advance, for example, via RRC signaling or SIB. The time duration may be measured utilizing the existing timer, or may be measured by providing a new timer. The existing timer includes, for example, one or more of the following: a timer T304, a timer T310 and a timer T311.

In addition, although not shown in the figure, the above method may further include the following step: reporting the transmission quality requirement of the data packet to be transmitted when applying for the configured grant resources from the base station.

In an example, the above method may further include: determining that a wireless link for the transmission of the UE fails and the UE performs cell reselection; and providing, in a case that a new base station connected after reselection is different from an original base station connected before reselection, an identifier of the original base station and an identifier of the user equipment in the original base station to the new base station.

In another example, the above method may further include: determining that the UE is to perform handover from a currently connected first base station to a second base station. In a handover process, the UE utilizes configured grant resources in a configured grant resource pool of the second base station. In a case that the first base station and the second base station utilize the same mapping relationship, a time duration during which the UE can utilize the configured grant resources of the second base station is determined based on the mapping relationship.

In a case that the first base station and the second base station utilize different mapping relationships, a mapping relationship of the second base station may be acquired through a handover command from the first base station, or information of the time duration during which the UE can utilize the configured grant resources of the second base station is acquired through the handover command.

In a case that the handover fails and the UE is connected to a third base station different from the second base station after cell reselection, an identifier of the second base station and an identifier of the UE in the second base station are provided to the third base station.

FIG. 11 shows a flow chart of a method for wireless communications according to another embodiment of the present disclosure. The method includes: providing, to UE which is to utilize configured grant resources in a configured grant resource pool to perform transmission, a mapping relationship between the transmission quality requirement of the data packet to be transmitted and the time duration during which the user equipment can continue utilizing the configured grant resources after detecting a physical layer problem; and configuring the configured grant resources for the UE. The method may be performed on, for example, a base station side.

Similarly, the transmission quality requirement may include, for example, one or more of the following: a requirement of reliability and a requirement of priority level. The mapping relationship may be set so that the higher the transmission quality requirement of the data packet to be transmitted is, the longer the time duration during which the user equipment can continue utilizing the configured grant resources is. In the step S21, the mapping relationship can be provided through RRC signaling or SIB.

In an example, the UE is connected to the first base station before reselection. The above method further includes: receiving, from the second base station connected after reselection, information of an identifier of the UE in the first base station and indication information indicating that the UE has been reselected to the second base station. When the information is received, the configured grant resources previously configured for the UE may be released. The information may be received, for example, via the X2 interface.

In another example, the above method further includes: transmitting, to the UE, a handover command indicating that the UE is switched from the currently connected first base station to the second base station. The handover command may include one of the following: an indication that the mapping relationship of the first base station is the same as the mapping relationship of the second base station; the mapping relationship of the second base station; and information of a time duration during which the UE can utilize configured grant resources of the second base station.

In another example, the UE is reselected from the original base station to a new base station, and the above method further includes: receiving, from the UE, the identifier of the original base station and the identifier of the UE in the original base station; and transmitting, to the original base station, information of the identifier of the UE in the original base station and indication information indicating that the UE has been switched to the new base station. The information and the indication information may be transmitted via the X2 interface.

The above methods respectively correspond to the electronic apparatus 100 described in the first embodiment and the second embodiment and the electronic apparatus 200 described in the third embodiment. For specific details, one may refer to the above corresponding description, and details are not repeated herein. It should be noted that the above methods may be implemented in combination with each other or separately.

The technology of the present disclosure may be applied to various products.

For example, the electronic apparatus 200 may be implemented as various base stations. The base station may be implemented as any type of evolved node B (eNB) or gNB (5G base station). The eNB includes, for example, a macro eNB and a small eNB. The small eNB may be an eNB covering a cell smaller than a macro cell, such as a pico eNB, a micro eNB, and a home (femto) eNB. The case for the gNB is similar to the above. Alternatively, the base station may be implemented as any other type of base station, such as a NodeB and a base transceiver station (BTS). The base station may include: a main body (also referred to as a base station apparatus) configured to control wireless communication; and one or more remote wireless head ends (RRH) located at positions different from the main body. In addition, various types of user equipment may each serves as a base station by performing functions of the base station temporarily or semi-permanently.

The electronic apparatus 100 may be implemented as various user equipments. The user equipment may be implemented as a mobile terminal (such as a smartphone, a tablet personal computer (PC), a notebook PC, a portable game terminal, a portable/dongle mobile router, and a digital camera) or a vehicle terminal (such as a car navigation apparatus). The user equipment may also be implemented as a terminal that performs machine-to-machine (M2M) communication (also referred to as a machine type communication (MTC) terminal). Furthermore, the user equipment may be a wireless communication module (such as an integrated circuitry module including a single die) mounted on each of the terminals described above.

[Application Example Regarding a Base Station]

### FIRST APPLICATION EXAMPLE

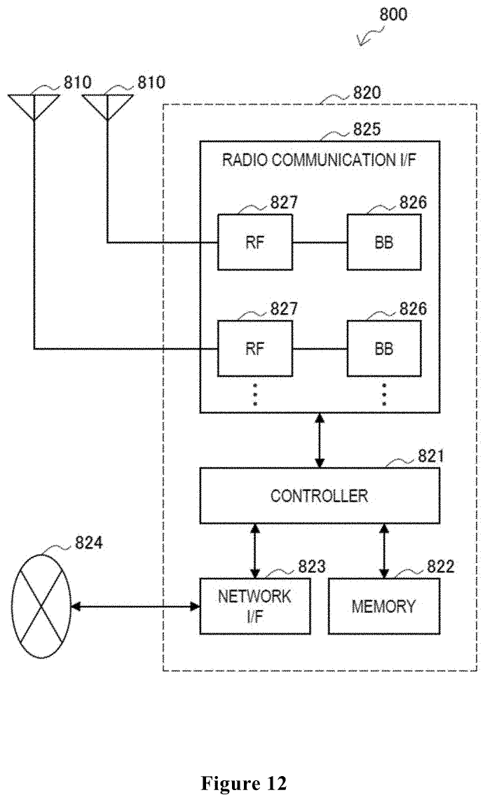

FIG. 12 is a block diagram showing a first example of an exemplary configuration of an eNB or gNB to which technology according to the present disclosure may be applied. It should be noted that the following description is given by taking the eNB as an example, which is also applicable to the gNB. An eNB 800 includes one or more antennas 810 and a base station apparatus 820. The base station apparatus 820 and each of the antennas 810 may be connected to each other via a radio frequency (RF) cable.

Each of the antennas 810 includes a single or multiple antennal elements (such as multiple antenna elements included in a multiple-input multiple-output (MIMO) antenna), and is used for the base station apparatus 820 to transmit and receive wireless signals. As shown in FIG. 12, the eNB 800 may include the multiple antennas 810. For example, the multiple antennas 810 may be compatible with multiple frequency bands used by the eNB 800. Although FIG. 12 shows the example in which the eNB 800 includes the multiple antennas 810, the eNB 800 may also include a single antenna 810.

The base station apparatus 820 includes a controller 821, a memory 822, a network interface 823, and a radio communication interface 825.

The controller 821 may be, for example, a CPU or a DSP, and operates various functions of a higher layer of the base station apparatus 820. For example, the controller 821 generates a data packet from data in signals processed by the radio communication interface 825, and transfers the generated packet via the network interface 823. The controller 821 may bundle data from multiple base band processors to generate the bundled packet, and transfer the generated bundled packet. The controller 821 may have logical functions of performing control such as radio resource control, radio bearer control, mobility management, admission control and scheduling. The control may be performed in corporation with an eNB or a core network node in the vicinity. The memory 822 includes a RAM and a ROM, and stores a program executed by the controller 821 and various types of control data (such as terminal list, transmission power data and scheduling data).

The network interface 823 is a communication interface for connecting the base station apparatus 820 to a core network 824. The controller 821 may communicate with a core network node or another eNB via the network interface 823. In this case, the eNB 800, and the core network node or another eNB may be connected to each other via a logic interface (such as an 51 interface and an X2 interface). The network interface 823 may also be a wired communication interface or a wireless communication interface for wireless backhaul. If the network interface 823 is a wireless communication interface, the network interface 823 may use a higher frequency band for wireless communication than that used by the radio communication interface 825.

The radio communication interface 825 supports any cellular communication scheme (such as Long Term Evolution (LTE) and LTE-advanced), and provides wireless connection to a terminal located in a cell of the eNB 800 via the antenna 810. The radio communication interface 825 may typically include, for example, a baseband (BB) processor 826 and an RF circuit 827. The BB processor 826 may perform, for example, encoding/decoding, modulating/demodulating, and multiplexing/demultiplexing, and performs various types of signal processing of layers (such as L1, Media Access Control (MAC), Radio Link Control (RLC), and a Packet Data Convergence Protocol (PDCP)). The BB processor 826 may have a part or all of the above-described logical functions instead of the controller 821. The BB processor 826 may be a memory storing communication control programs, or a module including a processor and a related circuit configured to execute the programs. Updating the program may allow the functions of the BB processor 826 to be changed. The module may be a card or a blade that is inserted into a slot of the base station apparatus 820. Alternatively, the module may also be a chip that is mounted on the card or the blade. Meanwhile, the RF circuit 827 may include, for example, a mixer, a filter, and an amplifier, and transmits and receives wireless signals via the antenna 810.

As shown in FIG. 12, the radio communication interface 825 may include the multiple BB processors 826. For example, the multiple BB processors 826 may be compatible with multiple frequency bands used by the eNB 800. The radio communication interface 825 may include multiple RF circuits 827, as shown in FIG. 12. For example, the multiple RF circuits 827 may be compatible with multiple antenna elements. Although FIG. 12 shows the example in which the radio communication interface 825 includes the multiple BB processors 826 and the multiple RF circuits 827, the radio communication interface 825 may also include a single BB processor 826 and a single RF circuit 827.

In the eNB 800 shown in FIG. 12, the providing unit 201 and the receiving unit 203 of the electronic apparatus 200 may be implemented by the radio communication interface 825. At least part of the functions may also be implemented by the controller 821. For example, the controller 821 may improve the communication reliability of the UE during the transition stage when the physical layer problem occurs or handover is performed, by performing the functions of the providing unit 201, the configuration unit 202 and the receiving unit 203.

### SECOND APPLICATION EXAMPLE

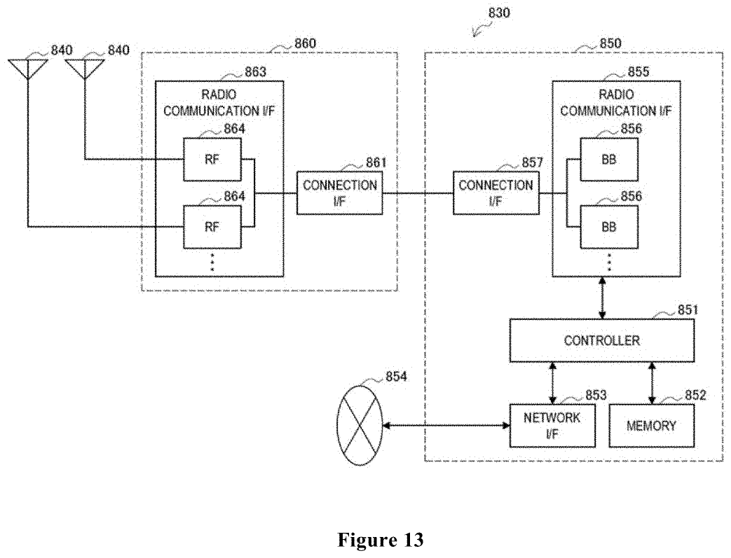

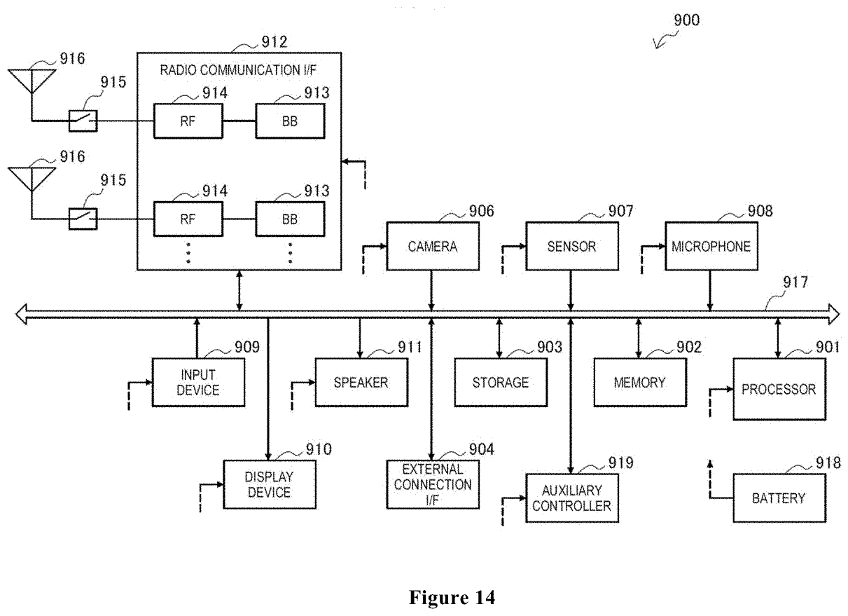

FIG. 13 is a block diagram showing a second example of the exemplary configuration of an eNB or gNB to which the technology according to the present disclosure may be applied. It should be noted that the following description is given by taking the eNB as an example, which is also applied to the gNB. An eNB 830 includes one or more antennas 840, a base station apparatus 850, and an RRH 860. The RRH 860 and each of the antennas 840 may be connected to each other via an RF cable. The base station apparatus 850 and the RRH 860 may be connected to each other via a high speed line such as an optical fiber cable.

Each of the antennas 840 includes a single or multiple antennal elements (such as multiple antenna elements included in an MIMO antenna), and is used for the RRH 860 to transmit and receive wireless signals. As shown in FIG. 13, the eNB 830 may include the multiple antennas 840. For example, the multiple antennas 840 may be compatible with multiple frequency bands used by the eNB 830. Although FIG. 13 shows the example in which the eNB 830 includes the multiple antennas 840, the eNB 830 may also include a single antenna 840.

The base station apparatus 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 12.

The radio communication interface 855 supports any cellular communication scheme (such as LTE and LTE-advanced), and provides wireless communication to a terminal located in a sector corresponding to the RRH 860 via the RRH 860 and the antenna 840. The radio communication interface 855 may typically include, for example, a BB processor 856.

The BB processor 856 is the same as the BB processor 826 described with reference to FIG. 12, except that the BB processor 856 is connected to an RF circuit 864 of the RRH 860 via the connection interface 857. As show in FIG. 13 the radio communication interface 855 may include the multiple BB processors 856. For example, the multiple BB processors 856 may be compatible with multiple frequency bands used by the eNB 830. Although FIG. 13 shows the example in which the radio communication interface 855 includes the multiple BB processors 856, the radio communication interface 855 may also include a single BB processor 856.

The connection interface 857 is an interface for connecting the base station apparatus 850 (radio communication interface 855) to the RRH 860. The connection interface 857 may also be a communication module for communication in the above-described high speed line that connects the base station apparatus 850 (radio communication interface 855) to the RRH 860.

The RRH 860 includes a connection interface 861 and a radio communication interface 863.

The connection interface 861 is an interface for connecting the RRH 860 (radio communication interface 863) to the base station apparatus 850. The connection interface 861 may also be a communication module for communication in the above-described high speed line.

The radio communication interface 863 transmits and receives wireless signals via the antenna 840. The radio communication interface 863 may typically include, for example, the RF circuit 864. The RF circuit 864 may include, for example, a mixer, a filter and an amplifier, and transmits and receives wireless signals via the antenna 840. The radio communication interface 863 may include multiple RF circuits 864, as shown in FIG. 13. For example, the multiple RF circuits 864 may support multiple antenna elements. Although FIG. 13 shows the example in which the radio communication interface 863 includes the multiple RF circuits 864, the radio communication interface 863 may also include a single RF circuit 864.

In the eNB 830 shown in FIG. 13, the providing unit 201 and the receiving unit 203 of the electronic apparatus 200 may be implemented by the radio communication interface 855 and/or the radio communication interface 863. At least part of the functions may also be implemented by the controller 851. For example, the controller 851 may improve the communication reliability of the UE during the transition stage when the physical layer problem occurs or handover is performed by performing functions of the providing unit 201, the configuration unit 202 and the receiving unit 203.

<Application Example Regarding User Equipment>

### FIRST APPLICATION EXAMPLE)

FIG. 14 is a block diagram showing an exemplary configuration of a smartphone 900 to which the technology according to the present disclosure may be applied. The smartphone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls functions of an application layer and another layer of the smartphone 900. The memory 902 includes a RAM and a ROM, and stores a program executed by the processor 901 and data. The storage 903 may include a storage medium such as a semiconductor memory and a hard disk. The external connection interface 904 is an interface for connecting an external device (such as a memory card and a universal serial bus (USB) device) to the smartphone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyro sensor, a geomagnetism sensor, and an acceleration sensor. The microphone 908 converts sounds that are inputted to the smartphone 900 to audio signals. The input device 909 includes, for example, a touch sensor configured to detect touch onto a screen of the display device 910, a keypad, a keyboard, a button, or a switch, and receives an operation or information inputted from a user. The display device 910 includes a screen (such as a liquid crystal display (LCD) and an organic light-emitting diode (OLED) display), and displays an output image of the smartphone 900. The speaker 911 converts audio signals that are outputted from the smartphone 900 to sounds.

The radio communication interface 912 supports any cellular communication scheme (such as LTE and LTE-advanced), and performs a wireless communication. The radio communication interface 912 may include, for example, a BB processor 913 and an RF circuit 914. The BB processor 913 may perform, for example, encoding/decoding, modulating/demodulating, and multiplexing/de-multiplexing, and perform various types of signal processing for wireless communication. The RF circuit 914 may include, for example, a mixer, a filter and an amplifier, and transmits and receives wireless signals via the antenna 916. It should be noted that although FIG. 14 shows a case that one RF link is connected to one antenna, which is only illustrative, and a case that one RF link is connected to multiple antennas through multiple phase shifters may also exist. The radio communication interface 912 may be a chip module having the BB processor 913 and the RF circuit 914 integrated thereon. The radio communication interface 912 may include multiple BB processors 913 and multiple RF circuits 914, as shown in FIG. 14. Although FIG. 14 shows the example in which the radio communication interface 912 includes the multiple BB processors 913 and the multiple RF circuits 914, the radio communication interface 912 may also include a single

BB processor 913 or a single RF circuit 914.

Furthermore, in addition to a cellular communication scheme, the radio communication interface 912 may support another type of wireless communication scheme such as a short-distance wireless communication scheme, a near field communication scheme, and a radio local area network (LAN) scheme. In this case, the radio communication interface 912 may include the BB processor 913 and the RF circuit 914 for each wireless communication scheme.

Each of the antenna switches 915 switches connection destinations of the antennas 916 among multiple circuits (such as circuits for different wireless communication schemes) included in the radio communication interface 912.

Each of the antennas 916 includes a single or multiple antenna elements (such as multiple antenna elements included in an MIMO antenna) and is used for the radio communication interface 912 to transmit and receive wireless signals. The smartphone 900 may include the multiple antennas 916, as shown in FIG. 14. Although FIG. 14 shows the example in which the smartphone 900 includes the multiple antennas 916, the smartphone 900 may also include a single antenna 916.

Furthermore, the smartphone 900 may include the antenna 916 for each wireless communication scheme. In this case, the antenna switches 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to blocks of the smart phone 900 shown in FIG. 14 via feeder lines that are partially shown as dashed lines in FIG. 14. The auxiliary controller 919, operates a minimum necessary function of the smart phone 900, for example, in a sleep mode.

In the smart phone 900 shown in FIG. 14, the transceiving unit 103 of the electronic apparatus 100 may be implemented by the radio communication interface 912. At least part of functions may also be implemented by the processor 901 or the auxiliary controller 919. For example, the processor 901 or the auxiliary controller 919 may improve the communication reliability of the UE during the transition stage when the physical layer problem occurs or handover is performed, by performing functions of the first determination unit 101, the second determination unit 102 and the transceiving unit 103.

### SECOND APPLICATION EXAMPLE

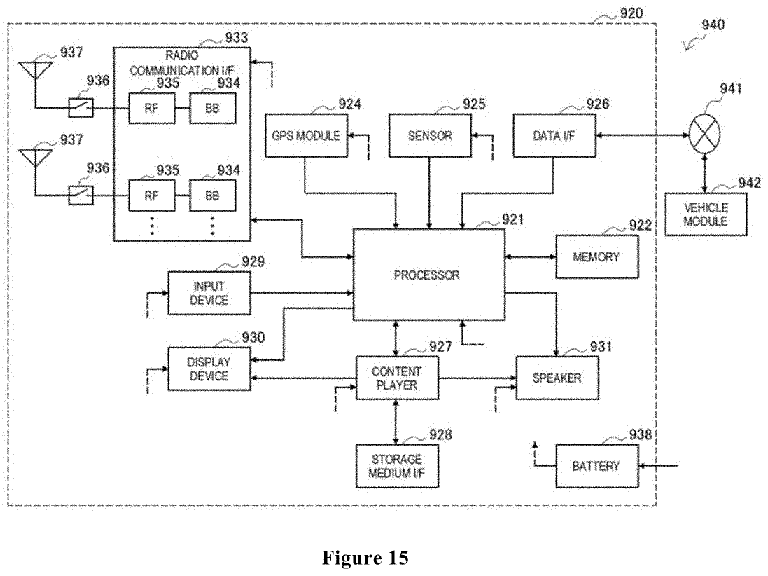

FIG. 15 is a block diagram showing an example of a schematic configuration of a car navigation apparatus 920 to which the technology according to the present disclosure may be applied. The car navigation apparatus 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example a CPU or a SoC, and controls a navigation function and additional function of the car navigation apparatus 920. The memory 922 includes RAM and ROM, and stores a program that is executed by the processor 921, and data.

The GPS module 924 determines a position (such as latitude, longitude and altitude) of the car navigation apparatus 920 by using GPS signals received from a GPS satellite. The sensor 925 may include a group of sensors such as a gyro sensor, a geomagnetic sensor and an air pressure sensor. The data interface 926 is connected to, for example, an in-vehicle network 941 via a terminal that is not shown, and acquires data (such as vehicle speed data) generated by the vehicle.

The content player 927 reproduces content stored in a storage medium (such as a CD and a DVD) that is inserted into the storage medium interface 928. The input device 929 includes, for example, a touch sensor configured to detect touch onto a screen of the display device 930, a button, or a switch, and receives an operation or information inputted from a user. The display device 930 includes a screen such as an LCD or OLED display, and displays an image of the navigation function or content that is reproduced. The speaker 931 outputs a sound for the navigation function or the content that is reproduced.

The radio communication interface 933 supports any cellular communication scheme (such as LTE and LTE-Advanced), and performs wireless communication. The radio communication interface 933 may typically include, for example, a BB processor 934 and an RF circuit 935. The BB processor 934 may perform, for example, encoding/decoding, modulating/demodulating and multiplexing/demultiplexing, and perform various types of signal processing for wireless communication. The RF circuit 935 may include, for example, a mixer, a filter and an amplifier, and transmits and receives wireless signals via the antenna 937. The radio communication interface 933 may also be a chip module having the BB processor 934 and the RF circuit 935 integrated thereon. The radio communication interface 933 may include multiple BB processors 934 and multiple RF circuits 935, as shown in FIG. 15. Although FIG. 15 shows the example in which the radio communication interface 933 includes the multiple BB processors 934 and the multiple RF circuits 935, the radio communication interface 933 may also include a single BB processor 934 and a single RF circuit 935.

Furthermore, in addition to a cellular communication scheme, the radio communication interface 933 may support another type of wireless communication scheme such as a short-distance wireless communication scheme, a near field communication scheme, and a wireless LAN scheme. In this case, the radio communication interface 933 may include the BB processor 934 and the RF circuit 935 for each wireless communication scheme.

Each of the antenna switches 936 switches connection destinations of the antennas 937 among multiple circuits (such as circuits for different wireless communication schemes) included in the radio communication interface 933.

Each of the antennas 937 includes a single or multiple antenna elements (such as multiple antenna elements included in an MIMO antenna), and is used by the radio communication interface 933 to transmit and receive wireless signals. As shown in FIG. 15, the car navigation apparatus 920 may include the multiple antennas 937. Although FIG. 15 shows the example in which the car navigation apparatus 920 includes the multiple antennas 937, the car navigation apparatus 920 may also include a single antenna 937.

Furthermore, the car navigation apparatus 920 may include the antenna 937 for each wireless communication scheme. In this case, the antenna switches 936 may be omitted from the configuration of the car navigation apparatus 920.

The battery 938 supplies power to the blocks of the car navigation apparatus 920 shown in FIG. 15 via feeder lines that are partially shown as dash lines in FIG. 15. The battery 938 accumulates power supplied from the vehicle.

In the car navigation apparatus 920 shown in FIG. 15, the transceiving unit 103 of the electronic apparatuses 100 may be implemented by the radio communication interface 933. At least part of functions may also be implemented by the processor 921. For example, the processor 921 may improve the communication reliability of the UE during the transition stage when the physical layer problem occurs or handover is performed by performing the functions of the first determination unit 101, the second determination unit 102 and the transceiving unit 103.

The technology of the present disclosure may also be implemented as an in-vehicle system (or a vehicle) 940 including one or more blocks of the car navigation apparatus 920, the in-vehicle network 941 and a vehicle module 942. The vehicle module 942 generates vehicle data (such as a vehicle speed, an engine speed, and failure information), and outputs the generated data to the in-vehicle network 941.

The basic principle of the present disclosure has been described above in conjunction with particular embodiments. However, as can be appreciated by those ordinarily skilled in the art, all or any of the steps or components of the method and apparatus according to the disclosure can be implemented with hardware, firmware, software or a combination thereof in any computing device (including a processor, a storage medium, etc.) or a network of computing devices by those ordinarily skilled in the art in light of the disclosure of the disclosure and making use of their general circuit designing knowledge or general programming skills.

Moreover, the present disclosure further discloses a program product in which machine-readable instruction codes are stored. The aforementioned methods according to the embodiments can be implemented when the instruction codes are read and executed by a machine.

Accordingly, a memory medium for carrying the program product in which machine-readable instruction codes are stored is also covered in the present disclosure. The memory medium includes but is not limited to soft disc, optical disc, magnetic optical disc, memory card, memory stick and the like.

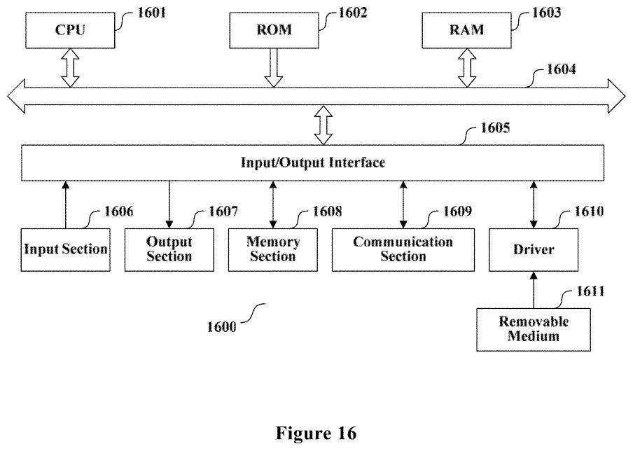

In the case where the present disclosure is realized with software or firmware, a program constituting the software is installed in a computer with a dedicated hardware structure (e.g. the general computer 1600 shown in FIG. 16) from a storage medium or network, wherein the computer is capable of implementing various functions when installed with various programs.

In FIG. 16, a central processing unit (CPU) 1601 executes various processing according to a program stored in a read-only memory (ROM) 1602 or a program loaded to a random access memory (RAM) 1603 from a memory section 1608. The data needed for the various processing of the CPU 1601 may be stored in the RAM 1603 as needed. The CPU 1601, the ROM 1602 and the RAM 1603 are linked with each other via a bus 1604. An input/output interface 1605 is also linked to the bus 1604.

The following components are linked to the input/output interface 1605: an input section 1606 (including keyboard, mouse and the like), an output section 1607 (including displays such as a cathode ray tube (CRT), a liquid crystal display (LCD), a loudspeaker and the like), a memory section 1608 (including hard disc and the like), and a communication section 1609 (including a network interface card such as a LAN card, modem and the like). The communication section 1609 performs communication processing via a network such as the Internet. A driver 1610 may also be linked to the input/output interface 1605, if needed. If needed, a removable medium 1611, for example, a magnetic disc, an optical disc, a magnetic optical disc, a semiconductor memory and the like, may be installed in the driver 1610, so that the computer program read therefrom is installed in the memory section 1608 as appropriate.

In the case where the foregoing series of processing is achieved through software, programs forming the software are installed from a network such as the Internet or a memory medium such as the removable medium 1611.

It should be appreciated by those skilled in the art that the memory medium is not limited to the removable medium 1611 shown in FIG. 16, which has program stored therein and is distributed separately from the apparatus so as to provide the programs to users. The removable medium 1611 may be, for example, a magnetic disc (including floppy disc (registered trademark)), a compact disc (including compact disc read-only memory (CD-ROM) and digital versatile disc (DVD), a magneto optical disc (including mini disc (MD)(registered trademark)), and a semiconductor memory. Alternatively, the memory medium may be the hard discs included in ROM 1602 and the memory section 1608 in which programs are stored, and can be distributed to users along with the device in which they are incorporated.

To be further noted, in the device, method and system according to the present disclosure, the respective components or steps can be decomposed and/or recombined. These decompositions and/or recombinations shall be regarded as equivalent solutions of the disclosure. Moreover, the above series of processing steps can naturally be performed temporally in the sequence as described above but will not be limited thereto, and some of the steps can be performed in parallel or independently from each other.

Finally, to be further noted, the term “include”, “comprise” or any variant thereof is intended to encompass nonexclusive inclusion so that a process, method, article or device including a series of elements includes not only those elements but also other elements which have been not listed definitely or an element(s) inherent to the process, method, article or device. Moreover, the expression “comprising a(n) . . . ” in which an element is defined will not preclude presence of an additional identical element(s) in a process, method, article or device comprising the defined “element(s)” unless further defined.

Although the embodiments of the present disclosure have been described above in detail in connection with the drawings, it shall be appreciated that the embodiments as described above are merely illustrative rather than limitative of the present disclosure. Those skilled in the art can make various modifications and variations to the above embodiments without departing from the spirit and scope of the present disclosure. Therefore, the scope of the present disclosure is defined merely by the appended claims and their equivalents.

1. An electronic apparatus for wireless communications, comprising:
processing circuitry, configured to:
determine that a physical layer problem occurs on transmission of user equipment which utilizes configured grant resources in a configured grant resource pool to perform the transmission; and
determine, according to a transmission quality requirement of a data packet to be transmitted, a time duration during which the user equipment can continue utilizing the configured grant resources.

2. The electronic apparatus according to claim 1, wherein the processing circuitry is configured to determine, based on a mapping relationship between the transmission quality requirement of the data packet to be transmitted and the time duration, the time duration corresponding to the transmission quality requirement.

3. The electronic apparatus according to claim 1, wherein the transmission quality requirement comprises one or more of the following: a requirement of reliability, a. requirement of priority level.

4. The electronic apparatus according to claim 2, wherein the processing circuitry is configured to acquire the mapping relationship from a base station in advance.

5. The electronic apparatus according to claim 4, wherein the processing circuitry is configured to acquire the mapping relationship via radio resource control signaling or a system information block.

6. The electronic apparatus according to claim 1, wherein the higher the transmission quality requirement of the data packet to he transmitted is, the longer the time duration during which the user equipment can continue utilizing the configured grant resources is.

7. The electronic apparatus according to claim 1, wherein the processing circuitry is further configured to utilize an existing timer to measure the time duration, or
provide a new timer to measure the time duration.

8. (canceled)

9. The electronic apparatus according to claim 7, wherein the existing timer comprises one or more of the following: a timer T304, a timer T310 and a timer T311.

10. The electronic apparatus according to claim 1, wherein the processing circuitry is further configured to report the transmission quality requirement of the data. packet to be transmitted to a base station when applying for the configured grant resources from the base station.

11. The electronic apparatus according to claim 1, wherein the processing circuitry is further configured to:
determine that a wireless link for the transmission of the user equipment fails and the user equipment performs cell reselection; and
provide, in a case that a new base station connected after reselection is different from an original base station connected before reselection, an identifier of the original base station and an identifier of the user equipment in the original base station to the new base station.

12. The electronic apparatus according to claim 2, wherein the processing circuitry is further configured to:
determine that the user equipment is to perform handover from a currently connected first base station to a second base station, wherein in a handover process, the user equipment utilizes configured grant resources in a configured grant resource pool of the second base station,
wherein, in a case that the first base station and the second base station utilize a same mapping relationship, the processing circuitry is configured to determine, based on the mapping relationship, a time duration during which the user equipment can utilize the configured grant resources of the second base station.

13. The electronic apparatus according to claim 12, wherein in a. case that the first base station and the second base station utilize different mapping relationships, the processing circuitry is configured to acquire a mapping relationship of the second base station through a handover command from the first base station, or
acquire information of the time duration during which the user equipment can utilize the configured grant resources of the second base station through a handover command from the first base station.

14. (canceled)

15. The electronic apparatus according to claim 12, wherein the processing circuitry is configured to: provide, in a case that the handover fails and the user equipment is connected to a third base station different from the second base station after cell reselection, an identifier of the second base station and an identifier of the user equipment in the second base station to the third base station.

16. An electronic apparatus for wireless communications, comprising:
processing circuitry, configured to:
provide, to user equipment which is to utilize configured grant resources in a configured grant resource pool to perform transmission, a mapping relationship between a transmission quality requirement of a. data packet to be transmitted and the time duration during which the user equipment can continue utilizing the configured grant resources after detecting a physical layer problem; and
configure the configured grant resources for the user equipment.

17. The electronic apparatus according to claim 16, wherein the processing circuitry is configured to provide the mapping relationship to the user equipment via radio resource control signaling or a system information block,
wherein the processing circuitry is configured to transmit to the user equipment, a handover command indicating, that the user equipment is switched from the currently connected first base station to the second base station, wherein the handover command comprises one of the following: an indication that a mapping relationship of the first base station is the same as a mapping relationship of the second base station, the mapping relationship of the second base station: and information of a time duration during which the UE can utilize configured grant resources of the second base station.

18.-19. (canceled)

20. The electronic apparatus according to claim 16, wherein electronic apparatus corresponds to a first base station to which the user equipment is connected before reselection, the processing circuitry is further configured to receive, from a second base station connected after reselection, information of an identifier of the user equipment in the first base station and indication information indicating that the user equipment has been reselected to the second base station.

21. The electronic apparatus according to claim 20, wherein the processing circuitry is further configured to release the configured grant resources previously configured for the user equipment.

22.-23. (canceled)

24. The electronic apparatus according to claim 16, wherein the user equipment is reselected from the original base station to a base station corresponding to the electronic apparatus, and the processing circuitry is further configured to receive, from the user equipment, an identifier of the original base station and an identifier of the user equipment in the original base station.

25. The electronic apparatus according to claim 24, wherein the processing circuitry is further configured to transmit, to the original base station, information of the identifier of the user equipment in the original base station and indication information indicating that the user equipment has been switched to the present base station.

26.-27. (canceled)

28. A method for wireless communications, comprising:
determining that a physical layer problem occurs on transmission of user equipment which utilizes configured grant resources in a configured grant resource pool to perform the transmission; and
determining, according to a transmission quality requirement of a data packet to be transmitted, a time duration during which the user equipment can continue utilizing the configured grant resources.

29.-30. (canceled)
